(19) United States
(12) Patent Application Publication
(10) Pub. No.: US 2002/0026954 A1
(43) Pub. Date: Mar. 7, 2002

(54) CLEANING METHOD AND APPARATUS

(76) Inventors: RICHARD ARTHUR TYLER, DUBLIN (IE); JEAN TYLER, DUBLIN (IE); DEREK KEOGH, DUBLIN (IE)

Correspondence Address: JACOBSON PRICE HOLMAN & STERN, 400 SEVENTH STREET NW, WASHINGTON, DC, 20004

(21) Appl. No.: 09/214,256

(22) PCT Filed: Jul. 1, 1997
(86) PCT No.: PCT/IE97/00045

(51) Int. Cl. B08B 7/04; B08B 9/00

(52) U.S. Cl. 134/37; 134/30; 134/34; 134/102.1; 15/302; 134/19

(57) ABSTRACT

Gum is removed by directing a steam jet (11) at an individual piece of gum (2) at a pressure sufficient to penetrate the gum. The steam temperature is sufficient to cause disintegration of the gum by the moistening effect of the steam. The gum disintegrates into particles (15) which can easily be swept up or removed by suction afterwards.

### FIELD OF THE INVENTION

The invention relates to a method and apparatus for cleaning the ground, and more particularly to removal of chewing gum from the ground. In this specification, the term “ground” is intended to mean both the ground and a floor.

### PRIOR ART DISCUSSION

While there have been many developments in technology for cleaning of the ground, little success has been achieved at removing gum. As people are aware, the composition of gum is such that it tends to harden with time until a stage is reached at which it becomes almost integrated into the ground. It thus becomes unsightly in public areas such as pedestrianised streets and shopping centres.

Prior attempts at removal of gum have fallen into three main categories, namely physical removal by scraping, use of chemical detergents, and use of high pressure water jets.

Regarding physical removal of the gum, this is a very time-consuming and awkward exercise which requires a very high labour input. Further, unless the floor is highly polished, it is often not possible to completely remove the gum in this manner, and a stain is left on the ground. The use of chemical detergents is sometimes satisfactory if it is used indoors and it can be satisfactorily removed afterwards. However, use of chemical detergents on the street and in pedestrian areas generally is not satisfactory because it must be very carefully supervised, can lead to environmental problems, and can stain some surfaces such as cobble-lock paving. Use of a high pressure water jet has been found to be successful—the physical force applied by the water jet physically removing the gum from the street. However, there are some problems associated with this method, the primary ones being that a stain may still be left where the surface is rough and the high pressures involved can cause damage to the ground. For example, high pressure water jets can loosen paving stones by removing grout and physically dislodging the stones. As more public areas become pedestrianised with such a covering, this problem has become more acute in recent years.

The prior art also includes a document, namely French Patent Specification No. FR 2723113 which describes a machine which incorporates features using some of the above principles. This machine has a complex head which is applied to the ground. The head has a rotating blade, a rotating brush, a suction tube, and a steam outlet. The head must be placed in position over the gum in a manner whereby the blade initially scrapes the bulk of the material away, and the brush then removes the remaining material. The steam outlet directs steam onto the bristles of the brush to heat up the bristles and the remaining gum to make it easier for the brush to remove the remaining gum. The suction tube removes the debris. It appears that this machine would be quite difficult to use because the head is quite large in relation to the typical size of a piece of gum on the ground. It would appear therefore to be quite difficult to correctly position the head so that the gum can be removed in the necessary cutting and brushing sequence. It also appears that this machine is quite complex because of the fact that both a blade and a brush must be driven, a suction tube operated, and steam delivered to the head.

### OBJECTS OF THE INVENTION

It is therefore an object of the invention to provide a method and apparatus for removal of gum in a more effective manner than has hereinbefore been the case. More particularly, it is an object to provide for removal of gum in a simple, quick and hygienic manner.

### SUMMARY OF THE INVENTION

According to the invention, there is provided a method of removing chewing gum from a surface, the method comprising the step of directing steam at the gum. Ideally, the steam has a temperature and pressure sufficient to cause disintegration of the gum into particles.

In a particularly preferred embodiment of the invention, the steam temperature is in excess of 140° C., preferably in excess of 150° C. and is typically approximately 170° C.

In a particularly preferred embodiment of the invention, the steam pressure is less than 50 bar.

In one preferred embodiment of the invention, the steam is directed at the gum for a time period of from 3 to 10 seconds, most preferably for a period of from 4 to 5 seconds.

The method preferably also comprises the further step of removing the particles after they have cooled to approximately ambient temperature.

In a preferred embodiment of the invention, the steam is directed at the gum at an acute angle to the horizontal to cause the particles to disperse to a cooler region before removal.

Typically, the steam flows in a jet from a nozzle. In a particularly preferred embodiment of the invention, the nozzle has a diameter in the range of 0.7 mm to 1.3 mm, most preferably 0.8 to 1.0 mm.

In a particularly preferred embodiment of the invention, the steam is directed at the gum in a jet having a diameter of less than 60 mm, most preferably less than 50 mm.

In one embodiment of the invention, the nozzle is at the end of a hand-held open lance. Preferably, the nozzle is coaxial with the lance.

Typically, the steam flowrate is in the range of 1.0 to 2.0 Kg/min.

The invention also provides a gum removal apparatus comprising:

mobile frame supporting:

water supply,

a water pump connected to said supply, and

a boiler having an inlet connected to the water pump, and an outlet, the boiler comprising means for delivering steam to the outlet: and

a steam nozzle connected to the boiler outlet and comprising means for directing a jet of steam.

Preferably, the nozzle is at the end of a hose having a handle for directing steam at gum. Ideally, the nozzle is at the end of an elongate rigid open lance having a handle and a control valve.

In one embodiment of the invention, the nozzle comprises means for directing the steam in a jet having a diameter of less than 60 mm.

In a particularly preferred embodiment of the invention, the nozzle has a diameter in the range of 0.7 to 1.3 mm, most preferably in the range of 0.8 to 1.0 mm.

Preferably, the nozzle is coaxial with the lance.

Ideally, the boiler comprises means for generating steam having a nozzle temperature of greater than 140° C., preferably approximately 170° C.

In a preferred embodiment of the invention, the boiler comprises means for generating steam having a nozzle backpressure of less than 50 bar.

Preferably, the water supply is a water reservoir mounted on the mobile frame.

Typically, the apparatus further comprises an electrical generator feeding power to the pump.

### DETAILED DESCRIPTION OF THE INVENTION

The invention will be more clearly understood from the following description of some embodiments thereof, given by way of example only with reference to the accompanying drawings in which:

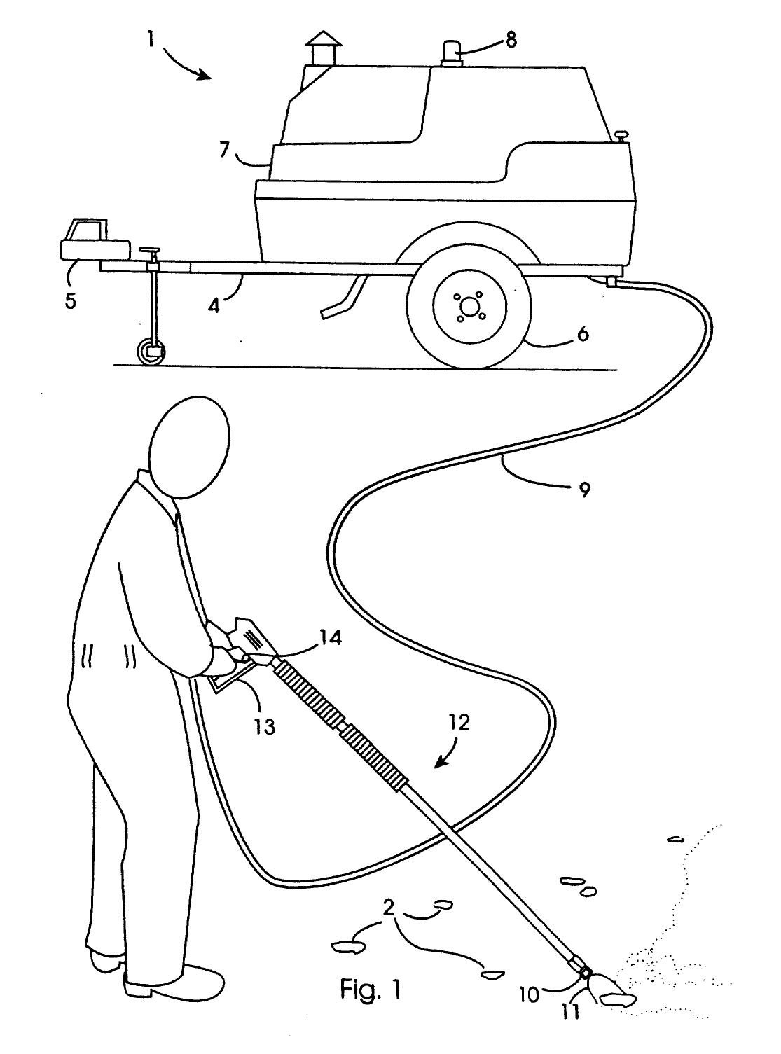

FIG. 1 is a diagrammatic view showing an operator using a gum removal machine of the invention;

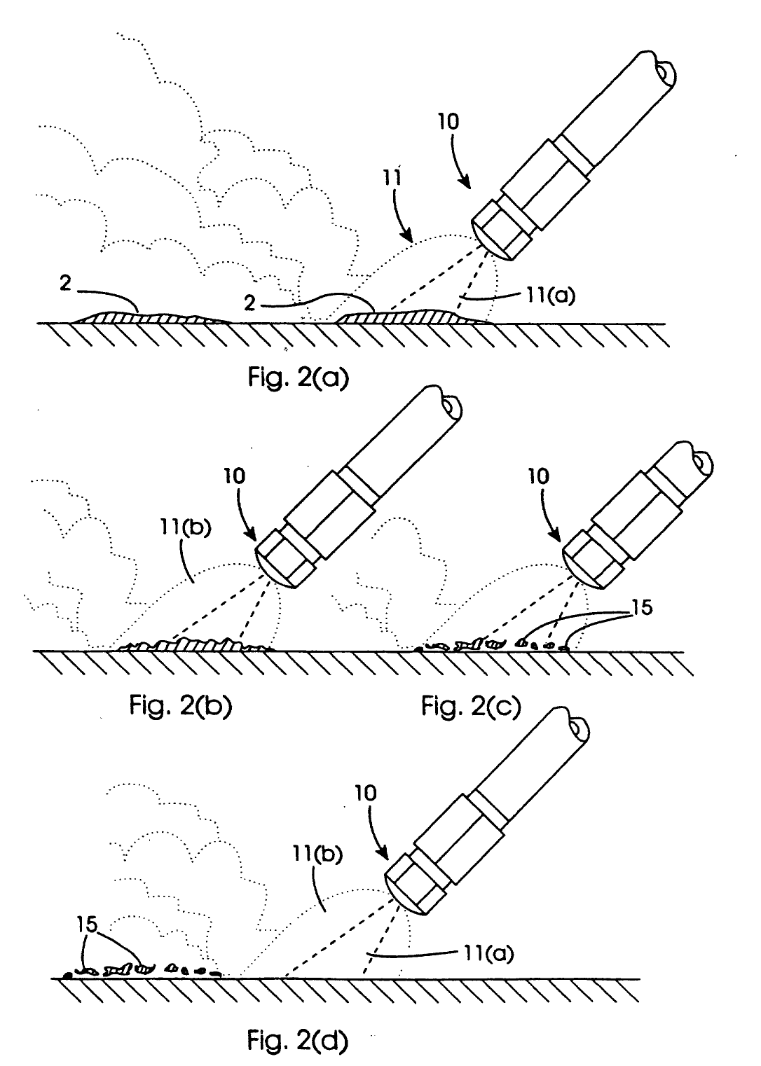

FIGS. 2(a) to 2(d) inclusive are diagrams illustrating the manner in which gum is removed;

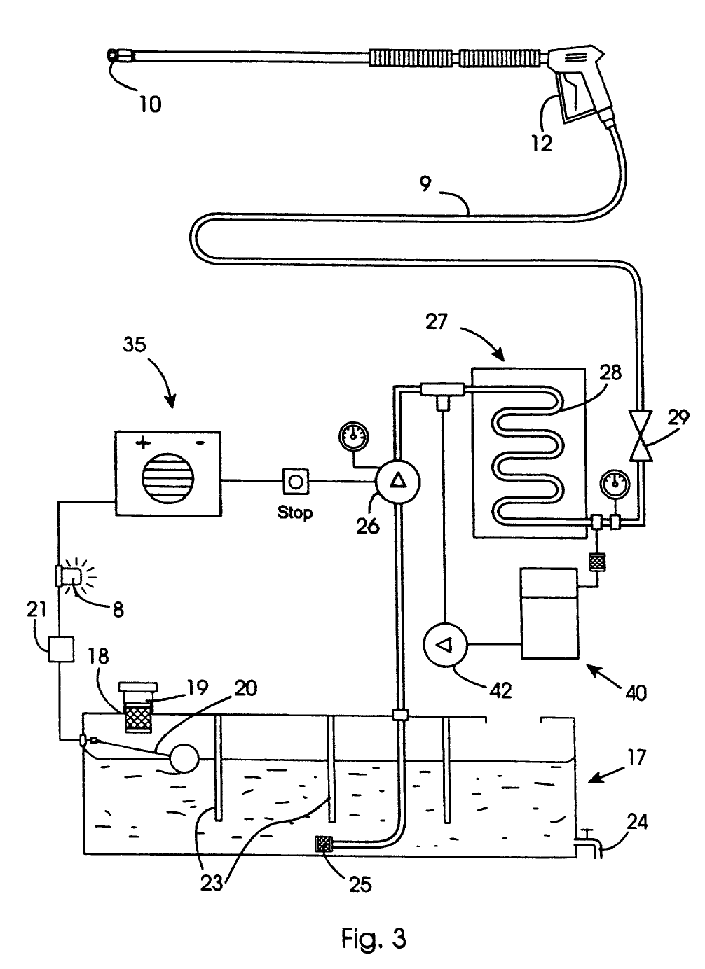

FIG. 3 is a diagram illustrating construction of the gum removal machine;

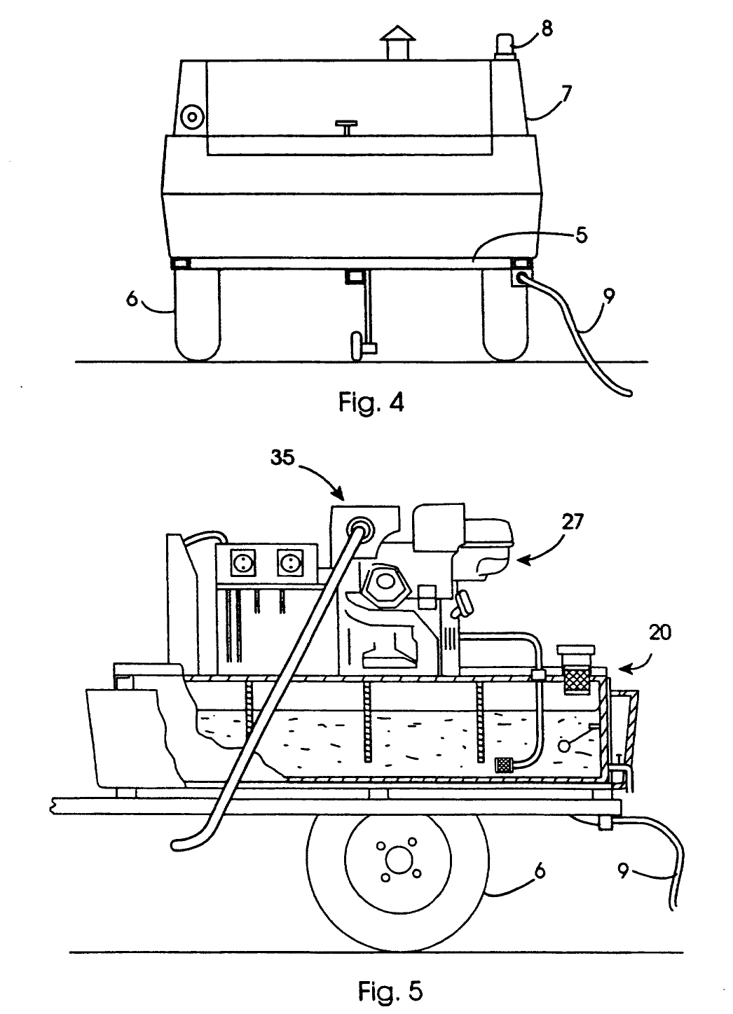

FIG. 4 is an end view of the machine with a cover in place;

FIG. 5 is a part cross-sectional side view of the machine; and

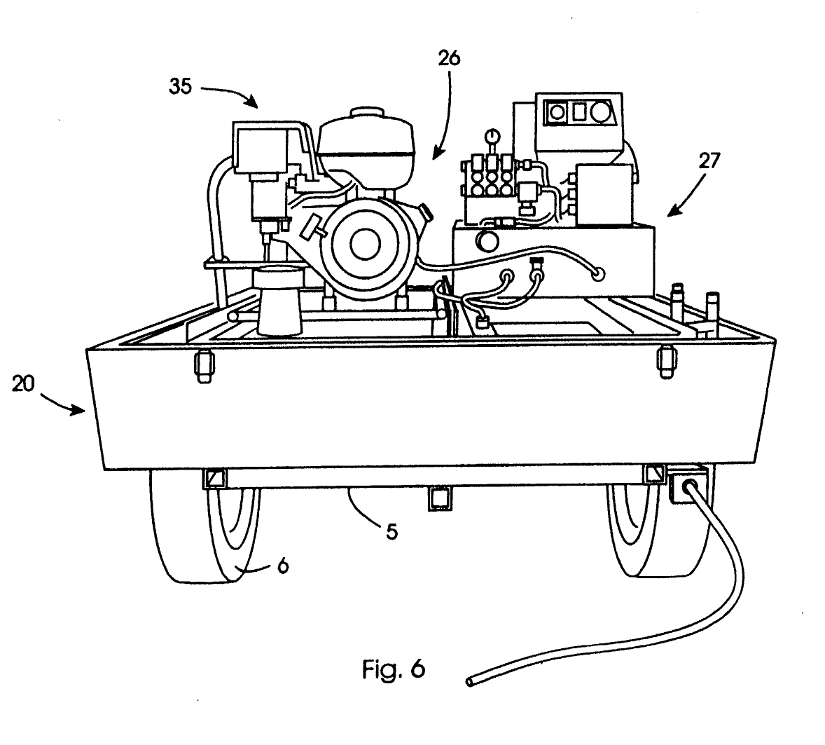

FIG. 6 is an end view of the machine with the cover removed.

Referring to the drawings, there is shown a gum removal machine 1 of the invention, being used by an operator to remove pieces of gum 2 on the street. The machine 1 comprises a chassis 4 having a tow hitch 5 and wheels 6. The functional parts of the machine 1 are covered by a cover 7 on which there is an indicator light 8, the purpose of which is described below. A boiler under the cover 7 delivers steam via a hose 9 to a nozzle 10, from which it is delivered as a steam jet 11. The nozzle 10 is at the end of an open hand-held lance 12 having a handle 14 with a control trigger 14.

Before describing construction of the machine 1 in detail, the manner in which gum is removed is now described with reference to FIGS. 2(a) to 2(d). The nozzle 10 has a diameter of 1 mm. Superheated steam from the boiler exits from the nozzle 10 as a high-velocity jet 11 having a central core stream 11(a) and a diffuse envelope 11(b). The steam has a temperature and pressure level sufficient to cause penetration of the body of each piece of gum and to cause disintegration of the gum into many small particles 15. It has been found that a combination of the pressure, the heating and the moistening effect causes the bonding agents in the gum to become ineffective and disintegration of the gum. The force and direction of the steam disperses the particles away from the original location to a cooler location as shown diagrammatically in FIG. 2(d), and they then re-solidify. At this stage, the particles may be easily swept up and disposed of. Alternatively, they may be removed by suction.

Thus, for removal of a piece of gum, the operator simply holds the lance 12 so that the nozzle 10 is in the region of 5 cm from the piece, operates the trigger 14, and directs the steam jet at an angle to the gum. The angled approach provides for penetration of the steam underneath the piece and allows quicker gum removal. Provided the steam has sufficient pressure, it takes only a few seconds to remove a single piece. The operator can easily control the nozzle position using the lance handle 13 and thus a large pedestrian area can be cleared quickly.

In more detail, it has been found that the gum can be removed within a very short time period which is within the range of 3 to 10 seconds, and is generally approximately 3 to 5 seconds. It has also been found that because the steam is directed from an open lance which is easily controlled by the operator, very quick progress can be made in clearing, for example a street, of gum. The use of an open lance instead of a head helps to ensure that there is no condensation and the steam is very effectively used for thorough gum removal. Also, the lance allows easy access to awkward locations such as within doorways and around drains, etc.

This very quick gum removal operation has been achieved by use of steam having a temperature and pressure which is sufficient to cause disintegration of the gum into particles. It has been found that a temperature in excess of 140° C. and preferably in excess of 150° C. is very effective. The steam pressure is preferably below 50 bar so that there is sufficient pressure to cause penetration of the gum and in combination with the steam temperature to cause disintegration of the gum into particles. This level of pressure does not cause damage to the ground surface such as grouting between paving stones.

If the lance is held at an acute angle to horizontal, there is the additional effect of blowing the particles away and causing them to disperse to locations away from the nozzle so that they can cool quickly. They may then be removed either by sweeping or by suction, usually within a few minutes. Direction of the steam jet at an angle also helps steam to penetrate underneath the gum and thus, while it is by no means essential to direct steam at an angle, it does help to speed up the gum disintegration process.

It has been found that the steam jet is best in a diameter of less than 60 mm and most preferably approximately 50 mm. The desired pressure and jet size has been achieved using a nozzle having a diameter of 1 mm. More generally, it has been found that a nozzle diameter in the range of 0.7 to 1.3 is effective, and most preferably in the range of 0.8 to 1.0. Also, it has been found that gum removal is particularly effective if the nozzle is coaxial with the lance. A steam flowrate in the range of 1.0 to 2.0 Kg/min has been found to be particularly effective.

In tests, we have found that a steam temperature in the region of 170° C. at the nozzle outlet is effective. The pressure of the steam in the line before the nozzle outlet is approximately 48 bar. At the exit from the nozzle, the force exerted by the steam is approximately 48 Newton or 10.97 lb force. Typically, the quantity of water used is 3 to 3.5 liters per minute if the lance is continuously operated. In use, however, the trigger is intermittently operated so that steam is delivered for approximately half the period that the unit is used.

The hose that is used to deliver steam from the boiler to the lance is typically 10 m long and has an inside bore of ⅜ inch.

Typically, the steam envelope has a width of approximately 5 cm as the steam contacts the gum. The hot central jet of steam delivered by the nozzle extends for a distance of approximately 2 cm from the nozzle tip.

In use, the nozzle is typically held at a distance of 1 to 2 cm away from the gum to disintegrate the gum. In some instances, particularly in areas where the ground is unsound or has substantial grouting, the nozzle may be held away from the gum by about 5 cm to initially soften the gum. The gum removal procedure typically takes less than 4 to 5 seconds.

Referring now to FIGS. 3 to 5 inclusive, construction of the machine 1 is now described. The machine 1 comprises a water reservoir 17 having an inlet 18 with a filter 10. A float 20 detects water level and is used by a circuit 21 to activate the lamp 8 to indicate low water level. The reservoir 18 comprises a set of intersecting baffles 23 which extend both longitudinally and transversely with respect to the direction of travel to reduce water displacement during travel.

A water outlet 25 having a filter is connected to a pump 26 which operates to deliver water to a spiral coil boiler 27 having spiral tubes 28. The boiler operates to deliver steam via a valve 29 to the hose 9. Electrical power is drawn from an on-board generator 35 which operates on petrol.

An auxiliary de-scaling detergent tank 40 and a pump 42 are provided. These have connections for direct supply of detergent into the boiler tubes at regular intervals to remove limescale. Alternatively, a water softening additive may be proportionately added to the water as it is being filled into the water reservoir. The proportionate mixing may be achieved, for example, using a venturi-type device.

As is clear from the drawings, the water reservoir occupies almost all of the chassis space, the other components being supported above on a framework. This allows efficient use of space with maximum water storage.

It will be appreciated that the invention provides for removal of gum in a very quick, simple and environmentally friendly manner. An operator may start on-site early in the morning and proceed along a street or a pedestrian pathway, for example. The lance allows very simple and effective control in which the operator has complete visibility and can very quickly direct steam at the gum pieces. Each piece is removed within a matter of a few seconds and the particles are dispersed forwardly if the lance is held at an acute angle as the operator moves forward. There is easy access to awkward locations such as crevices, around drains and close to doorways, etc. The particles are blown forward and at regular intervals, the operator can remove them by sweeping or by use of a conventional street-cleaning suction device.

When the operator is finished, not only has the gum been removed, but the street has a very fresh appearance. Further, no damage will have been caused to the ground even where cobble-lock paving stones are used with a loose grout. This is very important as it is quite expensive for local authorities to build such pedestrian areas and it is very important that damage is not caused by pressure washers. What the invention has achieved is the realisation that the steam on its own can be used in a very simple and effective manner to remove gum without the need for additional operations or equipment which add complexity.

The invention is not limited to the embodiments hereinbefore described, but may be varied in construction and detail.

1. A method of removing chewing gum from a surface, the method comprising the step of directing steam at the gum.

2. A method of removing chewing gum as claimed in claim 1, wherein the steam has a temperature and pressure sufficient to cause disintegration of the gum into particles.

3. A method of removing chewing gum as claimed in claim 1 or 2, wherein the steam temperature is in excess of 140° C.

4. A method of removing chewing gum as claimed in claim 3, wherein the steam temperature is in excess of 150° C.

5. A method of removing chewing gum as claimed in any preceding claim, wherein the steam temperature is approximately 170° C.

6. A method of removing chewing gum as claimed in any preceding claim, wherein the steam pressure is less than 50 bar.

7. A method of removing chewing gum as claimed in any preceding claim, wherein the steam is directed at the gum for a time period of 3 to 10 seconds.

8. A method of removing chewing gum as claimed in claim 7, wherein the steam is directed at the gum for a time period of 4 to 5 seconds.

9. A method of removing chewing gum as claimed in any of claims 2 to 9, comprising the further step of removing the particles after they have cooled to approximately ambient temperature.

10. A method of removing chewing gum as claimed in any preceding claim, wherein the steam is directed at the gum at an acute angle to the horizontal to cause the particles to disperse to a cooler region before removal.

11. A method of removing chewing gum as claimed in any preceding claim, wherein the steam flows in a jet from a nozzle.

12. A method of removing chewing gum as claimed in claim 11, wherein the nozzle has a diameter in the range of 0.7 mm to 1.3 mm.

13. A method of removing chewing gum as claimed in claim 12, wherein the nozzle has a diameter in the range 0.8 to 1.0 mm.

14. A method of removing chewing gum as claimed in any preceding claim, wherein the steam is directed at the gum in a jet having a diameter of less than 60 mm.

15. A method of removing chewing gum as claimed in claim 14, wherein the steam jet has a diameter of less than 50 mm.

16. A method of removing chewing gum as claimed in any of claims 11 to 15, wherein the nozzle is at the end of a hand-held open lance.

17. A method of removing chewing gum as claimed in claim 16, wherein the nozzle is coaxial with the lance.

18. A method of removing chewing gum as claimed in any preceding claim, wherein the steam flowrate is in the range of 1.0 to 2.0 Kg/min.

19. A method of removing chewing gum substantially as hereinbefore described with reference to the accompanying drawings.

20. A gum removal apparatus comprising:
mobile frame supporting:
water supply,
a water pump connected to said supply, and
a boiler having an inlet connected to the water pump, and an outlet, the boiler comprising means for delivering steam to the outlet: and
a steam nozzle connected to the boiler outlet and comprising means for directing a jet of steam.

21. An apparatus as claimed in claim 20, wherein the nozzle is at the end of a hose having a handle for directing steam at gum.

22. An apparatus as claimed in claim 21, wherein the nozzle is at the end of an elongate rigid open lance having a handle and a control valve.

23. An apparatus as claimed in any of claims 20 to 22, wherein the nozzle comprises means for directing the steam in a jet having a diameter of less than 60 mm.

24. An apparatus as claimed in any of claims 20 to 23, wherein the nozzle has a diameter in the range of 0.7 mm to 1.3 mm.

25. An apparatus as claimed in claim 24, wherein the nozzle has a diameter in the range of 0.8 to 1.0 mm.

26. An apparatus as claimed in any of claims 22 to 25, wherein the nozzle is coaxial with the lance.

27. An apparatus as claimed in any of claims 19 to 25, wherein the boiler comprises means for generating steam having a nozzle temperature of greater than 140° C.

28. An apparatus as claimed in claim 27, wherein the boiler comprises means for generating steam having a nozzle temperature of approximately 170° C.

29. An apparatus as claimed in any of claims 20 to 28, wherein the boiler comprises means for generating steam having a nozzle backpressure of less than 50 bar.

30. An apparatus as claimed in any of claims 20 to 29, wherein the water supply is a water reservoir mounted on the mobile frame.

31. An apparatus as claimed in any of claims 20 to 30, wherein the apparatus further comprises an electrical generator feeding power to the pump.

32. A gum removal apparatus substantially as hereinbefore described with reference to the accompanying drawings.
